(19) United States
(12) Patent Application Publication
(10) Pub. No.: US 2024/0361483 A1
(43) Pub. Date: Oct. 31, 2024

(54) PINPOINTER DETECTOR SHOWING SENSITIVITY ADJUSTMENTS AND MODE CHANGES

(71) Applicant: CONRAD DEDEKTÖR TEKNOLOJILERI VE MÜHENDISLIK HIZMETLERI TICARET LIMITED SIRKETI, Istanbul (TR)

(72) Inventor: EROL GÖKALP, Istanbul (TR)

(21) Appl. No.: 18/645,679

(22) Filed: Apr. 25, 2024

(30) Foreign Application Priority Data
Apr. 25, 2023 (TR) 2023/004520

(51) Int. Cl. G01V 3/165

(52) U.S. Cl. CPC G01V 3/165

(57) ABSTRACT

The invention is related to the detectors called pinpointer characterized in that it embodies a configuration which can visually transfer sensitivity adjustments and mode changes to the user.

### CROSS REFERENCE TO RELATED APPLICATIONS

This application claims priority to Turkish patent application TR 2023/004520, which was filed on Apr. 25, 2023, and which is hereby incorporated by reference as if set forth in its entirety.

### BACKGROUND

The invention is related to the detectors called pinpointer characterized in that it embodies a configuration which can visually transfer sensitivity adjustments and mode changes to the user.

Underground scanning devices or detectors with its commonly used name are used in order to detect non-precious metals hidden or embedded underground, precious metals such as gold and silver, underground structures, ancient underground settlements, underground differences or the structure of the ground. They are also used in order to ensure that the data found are processed by transferring the same to the other devices.

Devices called pinpointer are types of detectors too. Pinpointer systems detect the metals by a bobbin. It is easy to use since its size is averagely 25-30 cm and in the shape of a thin cylinder. Its small size and ease of use as part of its structure ensure that it is preferred and used in many challenging areas such as primarily under water.

Pinpointers currently in use are managed by the buttons on the body. Templates are also defined for the buttons on the device. For example; following templates are defined: device switches to root mode when button A and button B are pressed simultaneously or device switches to search mode when firstly button A and then, button B are pressed. Various sensitivity adjustments and/or mode changes are made with these templates. States such as sensitivity adjustments or mode changes are communicated to the user only via sound. For example; one long beep is defined as search mode or three short beeps as root mode.

It is fairly difficult for the user to learn these combinations. User must work with a user's manual or spend a long time to learn these combinations.

On the other hand, it is unlikely for hearing-impaired users to use them.

### SUMMARY

For a solution to the aforementioned problems, pinpointer detector showing sensitivity adjustments and mode changes has been developed. Disadvantages and problems arisen from the state of the art are eliminated by displaying the information of sensitivity adjustments or mode changes to the user through a visual interface positioned on the body.

Purpose of the invention is to acquire a pinpointer detector showing sensitivity adjustments and mode changes in which user can visually observe the changes in the adjustments and modes.

### BRIEF EXPLANATION OF FIGURES

Pinpointer detector showing sensitivity adjustments and mode changes in order to achieve the purpose of the invention is explained in detail with the FIGURES below:

FIG. 1: It is the perspective view of the pinpointer detector ready for use.

### DESCRIPTION OF PART REFERENCES

Additionally, FIGURES have been divided into parts/sections and explained in detail with their reference numbers:
1. Pinpointer detector
   1.1. Indicator panel,
   1.2. Indicators,
   1.3. Function buttons.

### DETAILED DESCRIPTION OF THE INVENTION

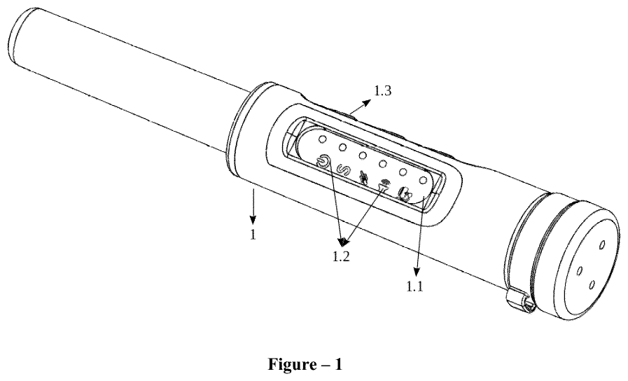

Pinpointer detector showing sensitivity adjustments and mode changes within the scope of the invention has been exemplified in FIG. 1.

Based on the figures and reference numbers forming the FIGURES; configuration ensuring that users can observe the changes on the pinpointer detector showing sensitivity adjustments and mode changes is comprised of indicator panel (1.1) positioned on the outer surface of the pinpointer detector (1), indicators (1.2) and function buttons (1.3).

Indicator panel (1.1) has been positioned on the body of the pinpointer detector (1) within the scope of the invention. It ensures that indicators (1.2) positioned under transparent indicator panel (1.1) can be seen. Indicators (1.2) have been created with different icons according to the intended use. It is likely to navigate among the indicators (1.2) with function buttons (1.3) with no need to complex button combinations and desired adjustment and mode changes can easily and visually be made. In any case this regulation that is compulsory for hearing-impaired users also provides users with no hearing-impairment with a considerable ease of use.

Preferably, in another embodiment of the invention, audible communication feature that can be used together with the indicators (1.2) is available too.

1. The invention is related to the pinpointer detector (1) showing sensitivity adjustments and mode changes in which user can visually observe the changes in the adjustments and modes without any button combination or audible communication, characterized by comprising the following;
i. transparent indicator panel (1.1) positioned on the body of the pinpointer detector (1)
ii. indicators (1.2) positioned under the indicator panel (1.1)
iii. function buttons (1.3) ensuring navigation among the indicators (1.2) and that desired adjustments and mode changes can be made
iv. audible communication feature that can be used together with the indicators (1.2).
